(19) United States
(12) Patent Application Publication
(10) Pub. No.: US 2025/0239713 A1
(43) Pub. Date: Jul. 24, 2025

(54) PORTABLE ELECTRICAL POWER SYSTEM

(71) Applicant: Norman R. Byrne, Ada, MI (US)

(72) Inventors: Parker Genau, Grand Rapids, MI (US); Andrew Stouffer, Grand Rapids, MI (US); Shawn R. Gibson, Fremont, MI (US); Daniel P. Byrne, Lowell, MI (US)

(21) Appl. No.: 19/029,572

(22) Filed: Jan. 17, 2025

Related U.S. Application Data
(60) Provisional application No. 63/622,364, filed on Jan. 18, 2024.

(51) Int. Cl. H01M 50/258; H01M 10/42; H01M 10/44; H01M 50/247; H01M 50/256; H01M 50/503; H02J 7/00; H02J 7/34; H02J 50/00; H02J 50/10

(52) U.S. Cl. CPC H01M 50/258; H01M 10/425; H01M 10/441; H01M 50/247; H01M 50/256; H01M 50/503; H02J 7/00034; H02J 7/0013; H02J 7/0044; H02J 7/342; H02J 50/10; H01M 2010/4278; H02J 50/005

(57) ABSTRACT

A portable electrical power system includes a portable electrical power unit with a power interface that improves the accessibility to power for electronic devices by having the capability to transfer power between electronic devices, other electrical power units, and/or utility power sources using wired and/or wireless power transmission. The power unit has an onboard rechargeable power source that can be charged in a variety of manners and from a variety of power sources to improve the usability of the power unit. The power unit may be arranged in a stacked configuration with other power units such that the power units are electrically coupled and can transfer power with one another. The stacked configuration of power units can provide more electronic devices access to electrical power without a larger footprint on a supporting surface and/or more external power connectors.

### CROSS REFERENCE TO RELATED APPLICATION

The present application claims the benefit of U.S. provisional application Ser. No. 63/622,364 filed Jan. 18, 2024, which is hereby incorporated herein by reference in its entirety.

### FIELD OF THE DISCLOSURE

The present disclosure relates to electrical power and, more particularly, to a portable electrical power system.

### BACKGROUND

The need or desire to access power has increased as portable electronic devices such as mobile phones, portable media players, laptop computers, and the like have proliferated. Such electronic devices may access power by using electrical power units that incorporate wireless and/or wired technology.

### SUMMARY

A portable electrical power system includes a portable electrical power unit with a power interface that improves the accessibility to power for electronic devices. The power unit can transfer power between electronic devices, other electrical power units, and/or utility power sources using wired and/or wireless power transmission. The power unit has an onboard rechargeable power source, such as a battery, that can be charged in a variety of manners and from a variety of power sources to improve the usability of the power unit.

The power unit can be arranged in a stacked configuration with one or more additional portable electrical power units. One of the power units in the stacked configuration may be electrically coupled to an external power connector such as, for example, an outlet of a utility power grid, and can distribute power from the external power connector to the other electrical power units in the stacked configuration. This allows more electronic devices to access electrical power via the plurality of electrical power units in the stacked configuration, without the need for a larger footprint on a surface supporting the stacked configuration and/or access to additional external power connectors for coupling to each of the power units in the stacked configuration. This charging and location flexibility allows users of electronic devices to more readily recharge their electronic devices in desired locations.

In one example of the present disclosure, an electrical power system includes first and second power units each including: opposing first and second horizontal surfaces, a vertical surface extending between the horizontal surfaces, an onboard rechargeable power source disposed between the surfaces, a first set of power contacts electrically coupled to the onboard power source and disposed on the first horizontal surface, second and third sets of power contacts electrically coupled to the onboard power source and disposed on the second horizontal surface, and a plurality of electrical receptacles electrically coupled to the onboard power source and disposed along the vertical surface.

In another example, the first and second power units can be arranged in a first configuration where the first horizontal surface of the first power unit is in contact with the second horizontal surface of the second power unit and the first set of power contacts of the first power unit: (i) is in contact with the second set of power contacts of the second power unit, (ii) can transmit electrical power to the second set of power contacts of the second power unit to charge the onboard power source of the second power unit, and (iii) can receive electrical power from the second set of power contacts of the second power unit to charge the onboard power source of the first power unit.

In yet another example, the first and second power units can be arranged in a second configuration where the second horizontal surface of the first power unit is in contact with the first horizontal surface of the second power unit and the first set of power contacts of the second power unit: (i) is in contact with the second set of power contacts of the first power unit, (ii) can transmit electrical power to the second set of power contacts of the first power unit to charge the onboard power source of the first power unit, and (iii) can receive electrical power from the second set of power contacts of the first power unit to charge the onboard power source of the second power unit.

In still another example, one or more of the electrical receptacles can transmit electrical power to an electronic device, and one or more of the electrical receptacles can receive electrical power from an external power source.

In a further example, the first and second power units can be arranged in a third configuration where the first horizontal surface of the first power unit is in contact with the second horizontal surface of the second power unit and the first set of power contacts of the first power unit: (i) is in contact with the third set of power contacts of the second power unit, (ii) can transmit electrical power to the third set of power contacts of the second power unit to charge the onboard power source of the second power unit, and (iii) can receive electrical power from the third set of power contacts of the second power unit to charge the onboard power source of the first power unit.

In yet another example, the first and second power units can be arranged in a fourth configuration where the second horizontal surface of the first power unit is in contact with the first horizontal surface of the second power unit and the first set of power contacts of the second power unit: (i) is in contact with the third set of power contacts of the first power unit, (ii) can transmit electrical power to the third set of power contacts of the first power unit to charge the onboard power source of the first power unit, and (iii) can receive electrical power from the third set of power contacts of the first power unit to charge the onboard power source of the second power unit.

In still another example, each of the power units includes a second vertical surface opposing the first vertical surface and extending between the horizontal surfaces. The first set of power contacts is disposed proximate to the second vertical surface, the second set of power contacts is disposed proximate to the second vertical surface, and the third set of power contacts is disposed proximate to the first vertical surface.

In a further example, each of the power units includes a first set of communication contacts disposed on the first horizontal surface and proximate to the first set of power contacts, a second set of communication contacts disposed on the second horizontal surface and proximate to the second set of power contacts, and a third set of communication contacts disposed on the second horizontal surface and proximate to the third set of power contacts. The communication contacts can provide information.

In yet another example, the power contacts of the first power unit can selectively transmit and receive electrical power based on information provided from at least one of the communication contacts of the first power unit, and the power contacts of the second power unit can selectively transmit and receive electrical power based on information provided from at least one of the communication contacts of the first power unit.

In still another example, the first set of power contacts of the first power unit can be selectively energized when the first set of communication contacts of the first power unit is in contact with and communicatively coupled to either one of the second and third sets of communication contacts of the second power unit. The second set of power contacts of the first power unit can be selectively energized when the second set of communication contacts of the first power unit is in contact with and communicatively coupled to the first set of communication contacts of the second power unit. The third set of power contacts of the first power unit can be selectively energized when the third set of communication contacts of the first power unit is in contact with and communicatively coupled to the first set of communication contacts of the second power unit.

In a further example, each of the first sets of power contacts and communication contacts includes two spring-loaded pins, and each of the second and third sets power contacts and communication contacts includes two contact pads.

In yet another example, each of the power units includes opposing second and third vertical surfaces extending from the first vertical surface and between the first and second horizontal surfaces. The second and third vertical surfaces define respective opposing recessed channels that can slidably engage with respective ribs disposed on a handle and/or a mount.

In still another example, the onboard power source of the first power unit will initially receive more electrical power from the external power source than the onboard power source of the second power unit when the power units are electrically coupled to one another, the onboard power source of the first power unit is at a lower charge level than the onboard power source of the second power unit, and one or more of the power units are receiving electrical power from an external power source.

In a further example, the onboard power source of the first power unit will receive electrical power from the onboard power source of the second power unit when the power units are electrically coupled to one another, and the onboard power source of the first power unit is at a lower charge level than the onboard power source of the second power unit.

In yet another example, each of the power units includes a housing forming at least a portion of the surfaces and containing the onboard power source. The housing defines a cavity that can hold an electronic tracking device.

In still another example, each of the power units includes a movable cover that can selectively conceal the cavity.

In a further example, each of the housings includes an interior projection having a first end proximate to the second horizontal surface and extending toward the first horizontal surface to a second end. The interior projection defines the cavity.

In yet another example, the electrical power system further includes a charging base having a platform, a fourth set of power contacts, and an electrical cord extending outwardly from the platform and having a distal end fitted with an electrical plug that can engage with an electrical receptacle of an external power source. The fourth set of power contacts is positioned to contact and be electrically coupled to either one of the second and third sets of power contacts.

In still another example, the second power unit is atop the first power unit when the first and second power units are arranged in the first configuration, and the first power unit is atop the second power unit when the first and second power units are arranged in the second configuration.

In another example of the present disclosure, an electrical power unit includes: opposing first and second horizontal surfaces, a vertical surface extending between the horizontal surfaces, an onboard rechargeable power source disposed between the surfaces, a first set of power contacts electrically coupled to the onboard power source and disposed on the first horizontal surface, second and third sets of power contacts electrically coupled to the onboard power source and disposed on the second horizontal surface, a plurality of electrical receptacles electrically coupled to the onboard power source and disposed along the vertical surface.

In another example, one or more of the electrical receptacles can selectively transmit electrical power to an electronic device.

In yet another example, one or more of the electrical receptacles can selectively receive electrical power from an external power source.

In still another example, the power contacts can: (i) selectively transmit electrical power to a second electrical power unit, and (ii) selectively receive electrical power from the second electrical power unit for charging the onboard power source.

Thus, the portable electrical power system improves the accessibility of power to electronic devices by having a portable electrical power unit with the capability to transfer power between electronic devices, other electrical power units, and/or utility power sources using wired and/or wireless power transmission. The power unit has an onboard rechargeable power source so that users of electronic devices can position the power unit in any desired location for charging their devices without needing continuous access to an external power connector such as, for example, an outlet of a utility power grid. Additionally, the power unit can be arranged in a stacked configuration with other electrical power units to provide more electronic devices access to electrical power without a larger footprint of a supporting surface and/or more external power connectors.

These and other objects, advantages, purposes, and features of this disclosure will become apparent upon review of the following specification in conjunction with the drawings.

### BRIEF DESCRIPTION OF DRAWINGS

FIG. 1 is a perspective view of a portable electrical power system having a plurality of portable electrical power units, including a single power unit atop a support structure, a single power unit below the support structure, and four power units in a matched-orientation stacked configuration atop a charging base that is atop the support structure;

FIG. 2 is a perspective view of one of the power units and the charging base of FIG. 1;

FIG. 3 is a perspective view of four of the power units of FIG. 1 in an alternating-orientation stacked configuration;

FIG. 4 is a bottom perspective view of one of the power units and the charging base of FIG. 1;

FIG. 5 is a front, top exploded perspective view of one of the power units of FIG. 1;

FIG. 6 is a front elevation view of one of the power units of FIG. 1;

FIG. 7 is a top plan view of one of the power units of FIG. 1;

FIG. 8 is a block diagram of a power interface and a battery of one of the power units of FIG. 1;

FIG. 9 is a front elevation view of a portable electrical power unit similar to one of the power units of FIG. 1;

FIG. 10 is a top plan view of the power unit of FIG. 9;

FIG. 11 is a bottom plan view of the power unit of FIG. 9;

FIG. 12 is a side elevation view of the power unit of FIG. 9;

FIG. 13 is a perspective view of another portable electrical power system having a plurality of portable electrical power units similar to the system of FIG. 1;

FIG. 14 is a perspective view of another portable electrical power system having a plurality of electrical power units similar to the system of FIG. 1;

FIG. 15 is a back, bottom perspective view of the power units of FIG. 14;

FIG. 16 is a partially exploded perspective view of a portable electrical power unit that is similar to one of the power units of FIG. 1 and a tracking device;

FIG. 17 is top perspective view of a portable electrical power unit similar to one of the power units of FIG. 1;

FIG. 18 is a bottom perspective view of the power unit of FIG. 17;

FIG. 19 is another bottom perspective view of the power unit of FIG. 17 having a cover shown in a closed position;

FIG. 20 is another bottom perspective view of the power unit of FIG. 17, showing the cover in an open position;

FIG. 21 is an exploded perspective view of the power unit of FIG. 17;

FIG. 22 is a top perspective view of the power unit of FIG. 17 and a mount;

FIG. 23 is a top perspective view of the power unit of FIG. 17 and a different mount;

FIG. 24 is a bottom perspective view of one of the power units of FIG. 1 having an extendable handle;

FIG. 25 is a perspective view of one of the power units of FIG. 1 having a handle for positioning the power unit below the support structure;

FIG. 26 is a perspective view of another portable electrical power unit similar to the power unit of FIG. 16 having a different handle;

FIG. 27 is a perspective view of another portable electrical power unit similar to the power unit of FIG. 16 having a different handle; and

FIG. 28 is a perspective view of another portable electrical power unit similar to the power unit of FIG. 16 having a different handle.

### DETAILED DESCRIPTION

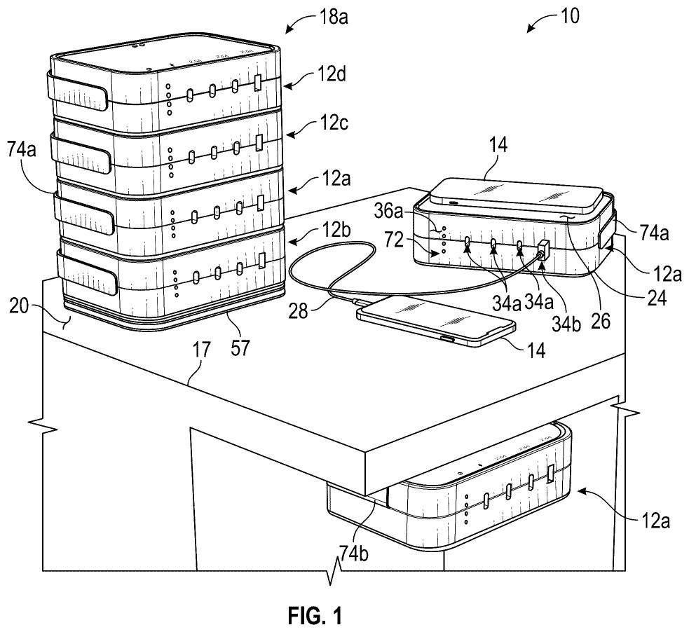

Referring now to the drawings and illustrative examples depicted therein, a portable electrical power system 10 has a portable electrical power unit 12a that is movable, stackable, and modular so that one or more mobile phones 14 can conveniently obtain power from the power unit 12a. (FIGS. 1-8). In other examples, any other suitable electronic device can obtain power from the power unit 12a such as, for example, a headphone charging case, a portable media player, a laptop computer, and the like.

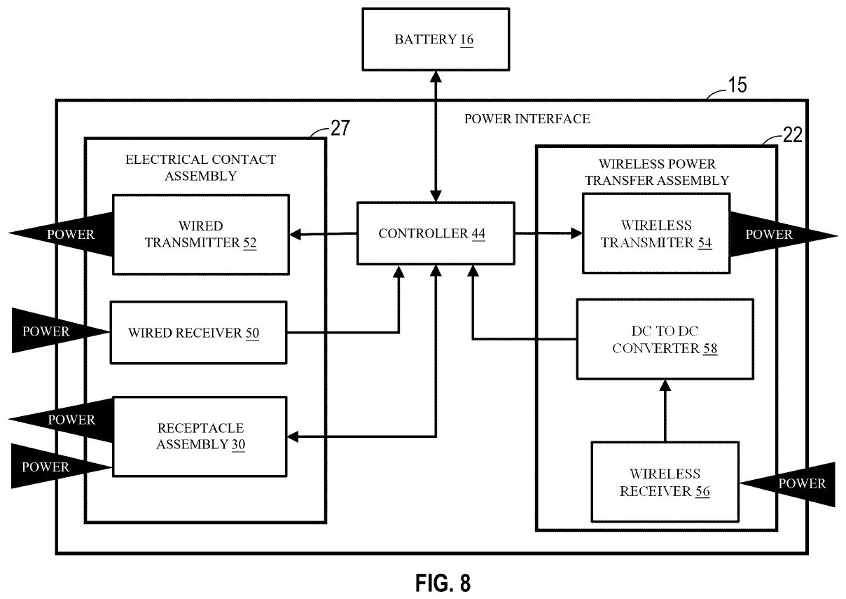

The power unit 12a has a power interface 15 that can provide power to the phones 14 using wired and/or wireless power transmission. (FIG. 8). This may provide users of phones 14 with flexibility for charging their phones 14. The power unit 12a has a rectangular shape with rounded corners. However, other suitable shapes of the power unit 12a are contemplated.

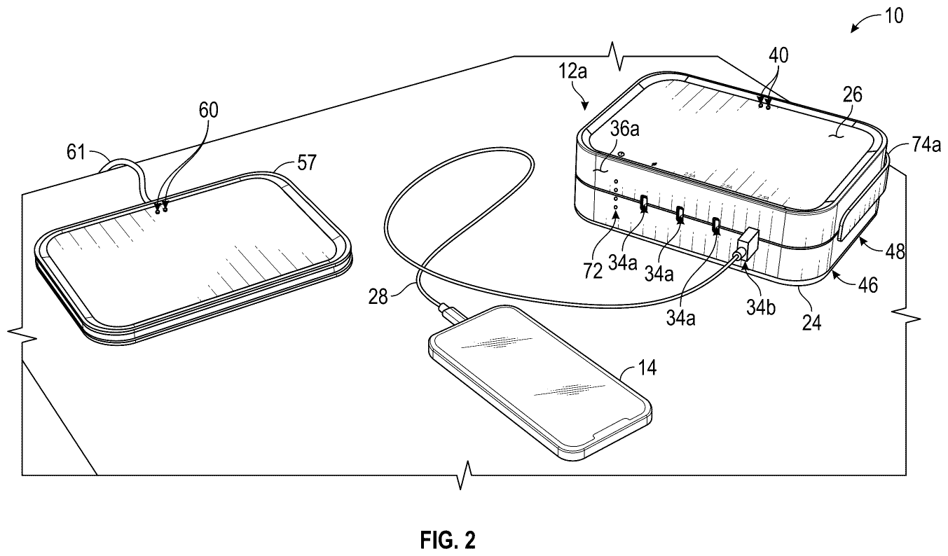

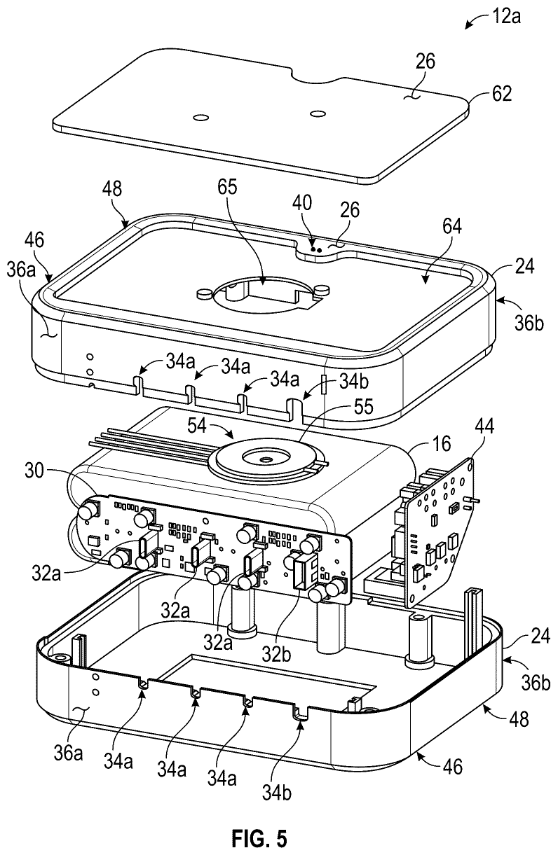

The power unit 12a has an onboard rechargeable power source in the form of a battery 16 that is electrically coupled to the power interface 15 and can store power so that the power unit 12a can be positioned in any desired location for charging the phones 14 without needing to be coupled to an external power connector such as, for example, an outlet of a utility power grid. (FIGS. 5-8). For example, the power unit 12a may be positioned atop a support structure 17, such as a table or a desk. (FIGS. 1, 2). In another example, the power unit 12a may be positioned below the support structure 17. (FIG. 1).

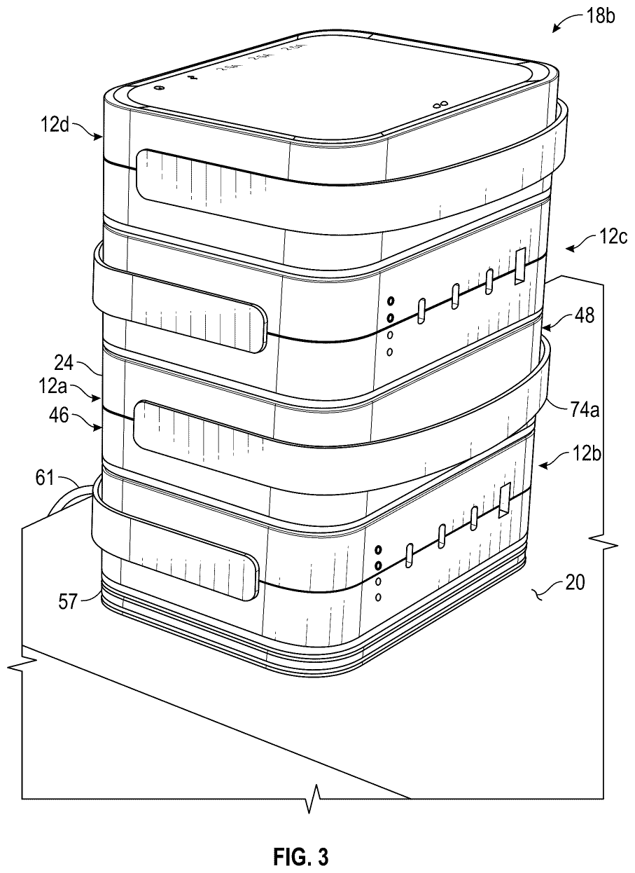

The system 10 has additional portable electrical power units 12b-d that may be similar and/or identical to the first power unit 12a. (FIGS. 1, 3). The first power unit 12a may be positioned within a matched-orientation stacked configuration 18a (FIG. 1) or an alternating-orientation stacked configuration 18b (FIG. 3) including the additional power units 12b-d. The power units 12a-d may be electrically coupled to one another when in the stacked configurations 18a, 18b.

The battery 16 of the first power unit 12a can be charged using a variety of methods such as, for example, wireless and/or wired power transmission. (FIGS. 5-8). Further, the battery 16 can be charged from a variety of power sources such as, for example, the other power units 12b-d, utility power sources, and/or electronic devices. This allows the battery 16 to be recharged and obtain a sufficient battery capacity for delivering power to the phones 14 without needing access to a specific power source.

The battery 16 can be charged by power obtained from one or more of the other power units 12b-d via the power interface 15 while the power units 12a-d are in any suitable stacked configuration 18a, 18b such as, for example, the matched-orientation stacked configuration 18a (FIG. 1) or the alternating-orientation stacked configuration 18b (FIG. 3). The stacked configurations 18a, 18b can be supported by a surface 20 of the support structure 17 to provide more phones 14 access to electrical power without occupying a larger footprint of the surface 20. (FIGS. 1, 3).

The stacked configurations 18a, 18b can improve power accessibility for phones 14 by reducing the amount of external power connectors (e.g., outlets of a utility power grid) needed to be electrically coupled to the power units 12a-d for charging their respective batteries. For example, the first power unit 12a may be arranged in the stacked configuration 18a, 18b and electrically coupled to an outlet of a utility power grid so that the first power unit 12a can receive power from the outlet and charge the battery 16. The first power unit 12a can deliver power from the outlet to the other power units 12b-d in the stacked configuration 18a, 18b for charging their respective batteries. As such, the batteries of the power units 12a-d can be charged via a single outlet. This allows more phones 14 to be charged by being able to receive power from not only from the first power unit 12a but also the from the other power units 12b-d without needing more outlets or other external power connectors for electrical coupling to each of the other power units 12b-d.

Thus, the portable electrical power unit 12a has location and charging flexibility so that mobile phones 14 can be readily recharged at desired locations. The power unit 12a can be charged from a variety of power sources to improve the usability of the power unit 12a. Further, the power unit 12a can be arranged in any suitable stacked configuration 18a, 18b with additional portable electrical power units 12b-d to provide more phones 14 access to electrical power without a larger footprint of the surface 20 and/or more external power connectors (e.g., outlets of a utility power grid).

Referring to FIGS. 1 and 8, the power unit 12a has a housing 24, and the power interface 15 has a wireless power transfer assembly 22 within the housing 24 for transferring power wirelessly from the power unit 12a to the phones 14 when in range to receive power from the wireless power transfer assembly 22. As shown in FIG. 1, the phone 14 is in range of the wireless power transfer assembly 22 when atop of or contacting an upper horizontal surface 26 of the power unit 12a such that the phone 14 can be electrically coupled to the wireless power transfer assembly 22 and obtain power for charging.

Referring to FIGS. 1-8, the power interface 15 of the power unit 12a includes an electrical contact assembly 27 having a receptacle assembly 30 for transferring power from the power unit 12a to the mobile phones 14 that are electrically coupled to the receptacle assembly 30 via one or more wires. For example, as shown in FIGS. 1 and 2, the phone 14 may be electrically coupled to the receptacle assembly 30 via a cord 28 including an electrical connector coupled to the receptacle assembly 30 and another electrical connector coupled to the phone 14 so that the phone 14 can obtain power for charging.

The receptacle assembly 30 includes a printed circuit board (PCB) such as, for example, a Universal Serial Bus (USB) board having USB Type-C electrical contacts or receptacles 32a and a USB Type-A electrical contact or receptacle 32b. (FIGS. 5-7). As shown in FIGS. 1 and 2, one of the electrical connectors of the cord 28 may be compatible with the USB Type-A electrical contact 32b.

The USB Type-C electrical contacts 32a align with openings 34a on a front vertical surface 36a of the housing 24 so that a cord with a USB Type-C connector can be inserted into one of the openings 34a and engage with the respective electrical contact 32a for transferring power with an electronic device or utility power source electrically coupled to another electrical connector of the cord. (FIG. 5). The USB Type-A electrical contact 32b aligns with the opening 34b on the front surface 36a so that the cord 28 with a USB Type-A connector, as shown in FIGS. 1 and 2, can be inserted into the opening 34b and engage with the electrical contact 32b for transferring power with the mobile phone 14 coupled to a different electrical connector of the cord 28. It will be appreciated that substantially any type of DC or AC contacts may be provided, optionally including a DC-to-AC converter, without departing from the spirit and scope of this disclosure.

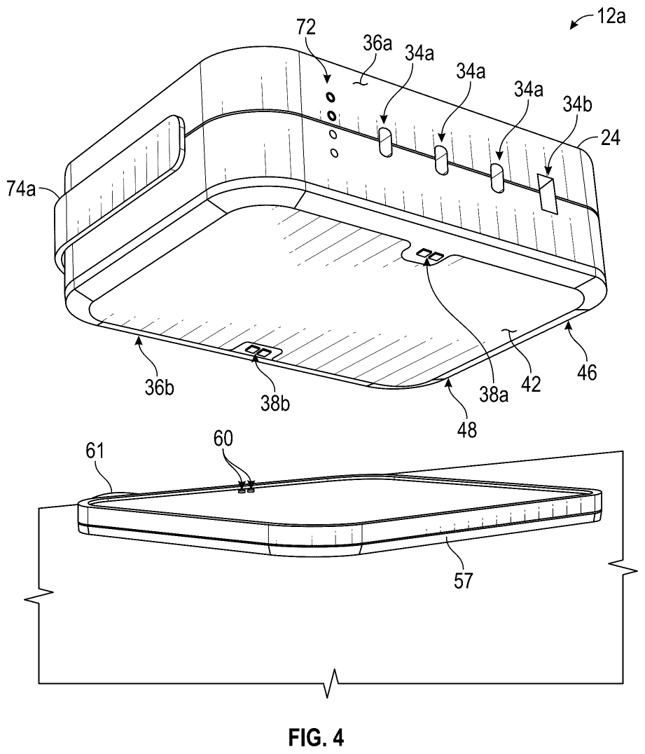

Referring to FIGS. 2, 4, 5, and 8, the electrical contact assembly 27 of the power interface 15 includes two sets of lower electrical contacts 38a, 38b that are positioned on a lower horizontal surface 42 of the power unit 12a, and a set of upper electrical contacts 40 that is positioned on the upper surface 26 of the power unit 12a. The first set of lower electrical contacts 38a includes a pair of flat contact pads disposed on a front portion 46 of the first power unit 12a, the second set of lower electrical contacts 38b includes a pair of flat contact pads disposed on a back portion 48 of the first power unit 12a, and the set of upper electrical contacts 40 includes a pair of spring-loaded pins (also known as “pogo-pins”) disposed on the back portion 48. As such, the first set of lower electrical contacts 38a is proximate to the front surface 36a, and the second set of lower electrical contacts 38b and set of upper electrical contacts 40 are proximate to a back vertical surface 36b of the housing 24. (FIGS. 4, 5).

The sets of electrical contacts 38a, 38b, 40 can transfer power between the battery 16 of the first power unit 12a and one or more of the other power units 12b-d such as, for example, while the first power unit 12a is placed in the stacked configuration 18a, 18b. (FIGS. 1, 3-5). As shown in FIGS. 1 and 3, the first power unit 12a is stacked atop or contacting the second power unit 12b so that power can transfer between the first and second power units 12a, 12b via one of the sets lower electrical contacts 38a, 38b of the first power unit 12a (FIG. 4) that is in contact with and electrically coupled to a set of upper electrical contacts of the second power unit 12b, which may be identical or similar to the set of upper electrical contacts 40 of the first power unit 12a (FIGS. 2, 5). The third power unit 12c is stacked atop or contacting the first power unit 12a so that power can transfer between the first and third power units 12a, 12c via the set of upper electrical contacts 40 of the first power unit 12a (FIGS. 2, 5) that is in contact with and electrically coupled to one of the sets of lower electrical contacts of the third power unit 12c, which may be identical or similar to one of the sets of lower electrical contacts 38a, 38b of the first power unit 12a (FIG. 4). The plurality of power units 12b-d may transfer power in a similar manner as described in connection with the first power unit 12a.

Because of the positions of the sets of lower electrical contacts 38a, 38b and the set of upper electrical contacts 40, substantially any suitable number of portable electrical power units 12a-d may be in a stacked configuration 18a, 18b for transferring power. Further, the sets of electrical contacts 38a, 38b, 40 allow the power units 12a-d to be positioned at different orientations about a vertical axis, as shown in the different stacked configurations 18a, 18b of FIGS. 1 and 3.

As shown in FIG. 1, the matched-orientation stacked configuration 18a includes the power units 12a, 12b oriented in the same direction. As such, the back set of lower electrical contacts 38b of the first power unit 12a (FIG. 4) can contact the set of upper electrical contacts on a back portion of the second power unit 12b for transferring power. The back set of lower electrical contacts 38b can be a wired receiver device 50 of the electrical contact assembly 27 while receiving power from the second power unit 12b, and a wired transmitter device 52 of the electrical contact assembly 27 while transmitting power to the second power unit 12b. (FIGS. 4, 8).

As shown in FIG. 3, the alternating-orientation stacked configuration 18b includes the power units 12a, 12b oriented in different directions. The first power unit 12a in the alternating-orientation stacked configuration 18b is rotated 180 degrees relative to the second power unit 12b from the orientation of the first power unit 12a shown in the matched-orientation stacked configuration 18a of FIG. 1. As such, the front set of lower electrical contacts 38a of the first power unit 12a can contact the set of upper electrical contacts positioned on the back portion of the of the second power unit 12b for transferring power. The front set of lower electrical contacts 38a can be the wired receiver device 50 of the electrical contact assembly 27 while receiving power from the second power unit 12b, and the wired transmitter device 52 while transmitting power to the second power unit 12b. (FIGS. 4, 8).

Regardless of the orientation of the power units 12a, 12b, the set of upper electrical contacts 40 can contact one of the sets of lower electrical contacts of the third power unit 12c for transferring power. (FIGS. 1, 3). The set of upper electrical contacts 40 can be the wired receiver device 50 while receiving power from the third power unit 12c, and the wired transmitter device 52 while transmitting power to the third power unit 12c. (FIGS. 2, 5, 8).

The power units 12a-d may transfer power based on whether one or more of them are receiving power from an external power source such as, for example, a utility power source, an electronic device (e.g., the phone 14), and the like. For example, when the power units 12a-d are in the stacked configuration 18a, 18b and one or more of the power units 12a-d are receiving power from an external power source, the same electric potential (e.g., 24 Volts) may be applied to each of the batteries of the power units 12a-d. This allows the batteries to charge at a rate proportional to the current voltage of the batteries relative to the maximum voltage of the batteries. As a result, each battery may charge at a rate proportional to the ratio of its current voltage to its maximum charged voltage when the power units 12a-d are in the stacked configuration 18a, 18b and one or more of the power units 12a-d are receiving power from an external power source.

In another example of transferring power between the power units 12a-d in the stacked configuration 18a, 18b when one or more of the power units 12a-d are receiving power from an external power source, one or more batteries of the power units 12a-d may be prioritized for charging over other batteries of the power units 12a-d. The batteries of the power units 12a-d may be prioritized for charging based on their charge levels or states of charge. For example, batteries having a lower charge level may be prioritized for charging and receive more power than the other batteries. As such, for example, if the battery 16 of the power unit 12a has a charge level lower than the batteries of the power units 12b-d, the battery 16 of the power unit 12a may be prioritized for charging and receive more power than the batteries of the power units 12b-d.

If two or more of the batteries of the power units 12a-d are not fully charged, the two or more batteries may be prioritized so that they become fully charged at the same time. For example, the lowest-charged battery may be first prioritized and receive the most power until it reaches a desired intermediate charge level such as, for example, a charge level of the highest-charged battery that is not fully charged. The other batteries not fully charged may then receive the most power in an order from least to most charged until all of them reach the desired intermediate charge level. The batteries at the desired intermediate charge level may then be charged so that they become fully charged at the same time.

One or more of the power units 12a-d may include a controller that determines the prioritization of the power units 12a-d. For example, the power interface 15 of the first power unit 12a has a controller 44 that may determine charge levels of the batteries of the power units 12a-d. (FIGS. 5-8). The controller 44 may be implemented by hardware, software, firmware, and/or any combination of hardware, software, and/or firmware. The controller 44 may regulate power supplied to the battery 16 and/or transferred to the other power units 12b-d based on the determined prioritization of the power units 12a-d.

When the power units 12a-d are in the stacked configuration 18a, 18b and not receiving power from an external power source, the batteries of the power units 12a-d at different voltages may naturally balance or equalize their voltage by transferring power between the power units 12a-d. One or more of the power units 12a-d may include a controller that can prevent the equalization of the power units 12a-d. For example, the controller 44 of the power unit 12a may include a control PCB having a diode for allowing current to enter the battery 16 only when at least one of the power units 12a-d in the stacked configuration 18a, 18b are receiving power from an external power source. As a result, the controller 44 can prevent current from exiting the battery 16 and the first power unit 12a via the sets of electrical contacts 38a, 38b, 40 while the power units 12a-d are not receiving power from an external power source.

Referring to FIGS. 5-8, the wireless power transfer assembly 22 of the first power unit 12a has a wireless electrical power transmitter device 54 such as, for example, a transmitter that can transmit power according to a Qi standard for transferring power from the battery 16 to the mobile phone 14 using wireless power transmission. In other examples, the wireless transmitter 54 may use any suitable wireless power transfer technology for charging the mobile phone 14 such as, for example, magnetic resonance, magnetic induction, and/or electromagnetic waves.

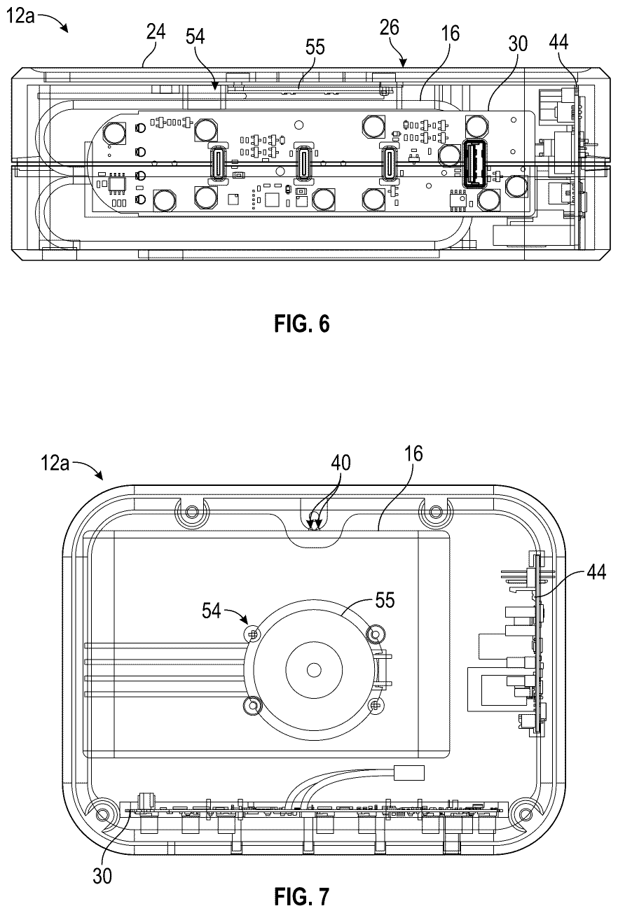

The wireless transmitter 54 is disposed above the battery 16 and proximate to the upper surface 26 of the power unit 12a. (FIGS. 5, 6). The wireless transmitter 54 has a transmitter coil 55 that can generate a magnetic field to induce a current in a receiving coil of the mobile phone 14 and transfer power to the mobile phone 14. (FIGS. 1, 5-7).

The power unit 12a has a panel 62 for covering the wireless transmitter 54. (FIG. 5). The panel 62 forms a portion of the upper surface 26 and allows the wireless power transfer assembly 22 to transfer power from the wireless transmitter 54 to the mobile phones 14 and/or the other power units 12b-d. The housing 24 defines a recess 64 having an opening 65 that is aligned with the wireless transmitter 54. The recess 64 can receive the panel 62, and the panel 62 may be removable or fixed to the housing 24.

The battery 16 of the first power unit 12a has one or more rechargeable onboard energy storage devices such as, for example, a lithium-based battery, a capacitor, and/or a fuel cell that allows for many cycles of energizing and de-energizing the energy storage device. (FIGS. 5-8). As discussed previously, the battery 16 can be charged from a variety of power sources such as, for example, the other power units 12a-d. The battery 16 can also be charged from an external power source by wired transmission via the receptacle assembly 30. For example, a cord may be electrically coupled to one of the electrical contacts 32a, 32b and the external power source, such as a utility power source or an electronic device (e.g., the mobile phone 14), so that the cord can transmit power from the external power source to the battery 16.

Power can be transmitted to the battery 16 from an external power source via a charging base 57. (FIGS. 1-4). The charging base 57 includes a platform with a wired power input and an upper shape that generally mimics the shape of the upper surface 26 of the power unit 12a so that the power unit 12a can be atop the charging base 57 as if it is atop one of the other power units 12b-d. For example, as shown in FIGS. 2 and 4, the charging base 57 has a set of upper electrical contacts 60 including a pair of spring-loaded pins that can obtain power from a utility power source via a cord 61. The cord 61 is electrically coupled to the wired power input of the charging base 57, extends outwardly away from the charging base 57, and has a distal end fitted with an electrical plug that can engage with an electrical receptacle or outlet connected to a utility power source or grid.

The charging base 57 may include an AC-to-DC electrical power converter that can receive high voltage AC electrical power from the cord 61, and output low voltage DC electrical power to the upper electrical contacts 60. As such, the upper electrical contacts 60 can be electrically energized by power delivered to the charging base 57 from the cord 61, and power can be transferred to one of the sets of lower electrical contacts 38a, 38b of the power unit 12a in contact with and electrically coupled to the upper electrical contacts 60.

The wireless power transfer assembly 22 of the power unit 12a includes a wireless electrical power receiver device 56 such as, for example, a receiver that can receive power according to a Qi standard so that power can be transmitted wirelessly to the wireless receiver 56 for charging the battery 16. (FIG. 8). In other examples, the wireless receiver 56 may use any suitable wireless power transfer technology such as, for example, magnetic resonance, magnetic induction, and/or electromagnetic waves. The wireless power transfer assembly 22 has a DC-to-DC electrical power converter 58 that can receive current from the wireless receiver 56, and output current of a different voltage level to the battery 16. (FIG. 8).

The wireless receiver 56 can obtain power from one or more electronic devices that have wireless power output capabilities and are in range to wirelessly transfer power to the wireless receiver 56 such as, for example, one or more of the mobile phones 14, other power units 12b-d, and/or charging base 57. (FIGS. 1-4 and 8). The second power unit 12b, for example, may have a transmitter coil that can generate a magnetic field to induce a current in a receiving coil of the wireless receiver 56 for transferring power wirelessly to the wireless receiver 56. (FIGS. 1, 3, 8).

The controller 44 of the power interface 15 may regulate the power of the battery 16. (FIG. 8). For example, the controller 44 may be communicatively coupled to the battery 16, the wireless transmitter 54, the wireless receiver 56, the DC-to-DC converter 58, and/or the electrical contact assembly 27.

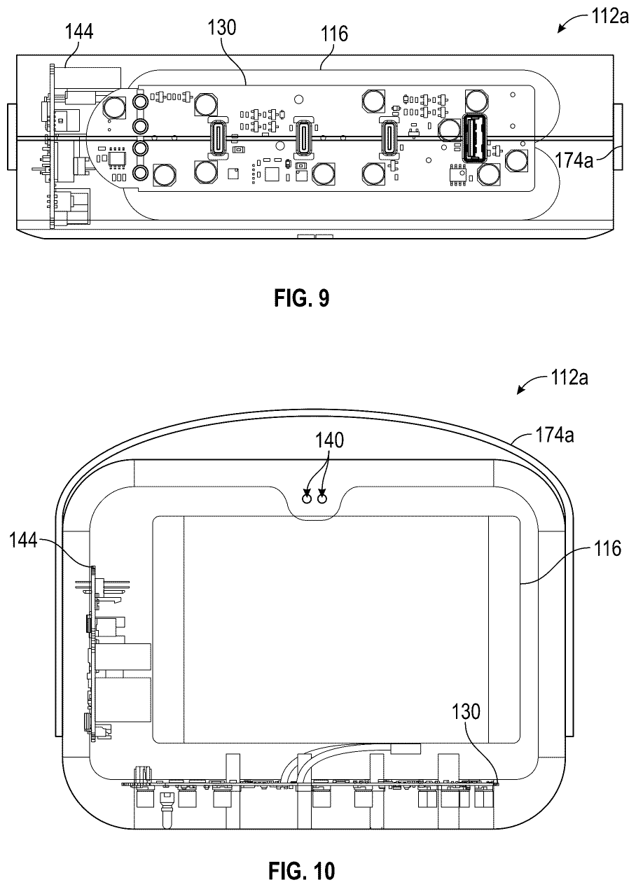

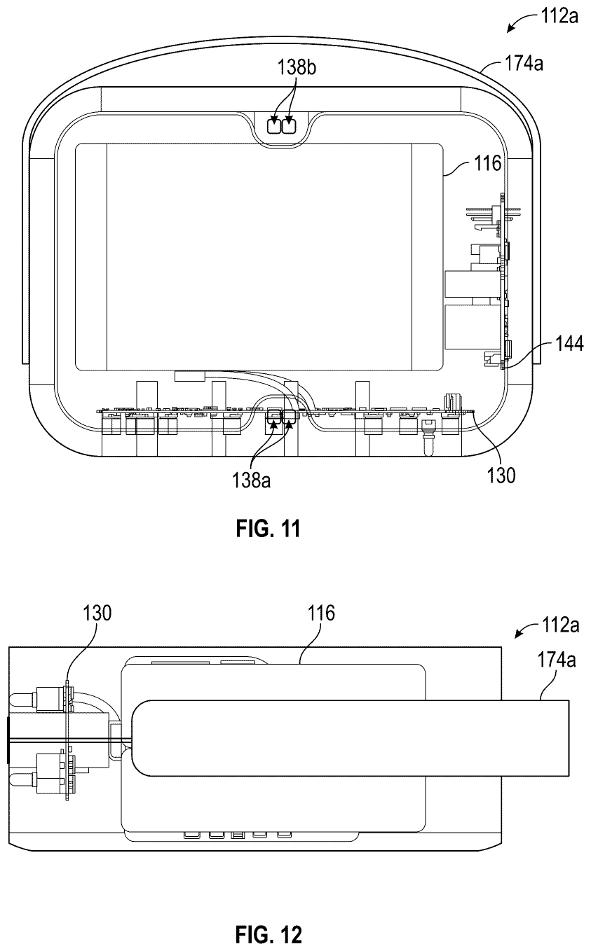

It should be appreciated that other examples of the power unit 12a and power system 10 are envisioned. For example, FIGS. 9-12 show another example of a portable electrical power unit 112a that is similar to the power unit 12a shown in FIGS. 1-8 but does not have a wireless power transfer assembly. The corresponding elements of the power unit 112a use like reference numbers having the same last two digits (e.g., a battery 116 of the power unit 112a is the same or like the battery 16 of the power unit 12a). The power unit 112a includes a receptacle assembly 130 and sets of electrical contacts 138a, 138b, 140 that can transfer power between the battery 116 and other power units, electronic devices, and/or utility power sources.

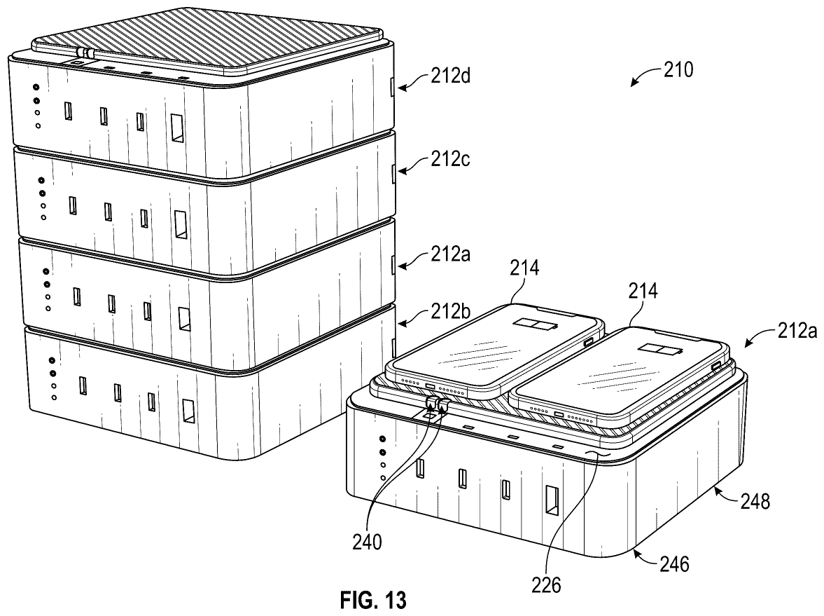

FIG. 13 shows another example of an electrical power system 210 including a first portable electrical power unit 212a that is similar to the power unit 12a shown in FIGS. 1-8 but can wirelessly transfer power to more than one phone 214 simultaneously. The corresponding elements of the electrical power system 210 use like reference numbers having the same last two digits (e.g., an upper surface 226 is like the upper surface 26). The power unit 212a has the upper surface 226 that can support more than one phone 214 for wirelessly charging the phones 214. The power unit 212a includes a set of upper electrical contacts 240 positioned on a front portion 246 of an upper surface 226 of the power unit 212a. The set of upper electrical contacts 240 includes a pair of angled contact pads that can contact a pair of electrical contacts for electrical coupling.

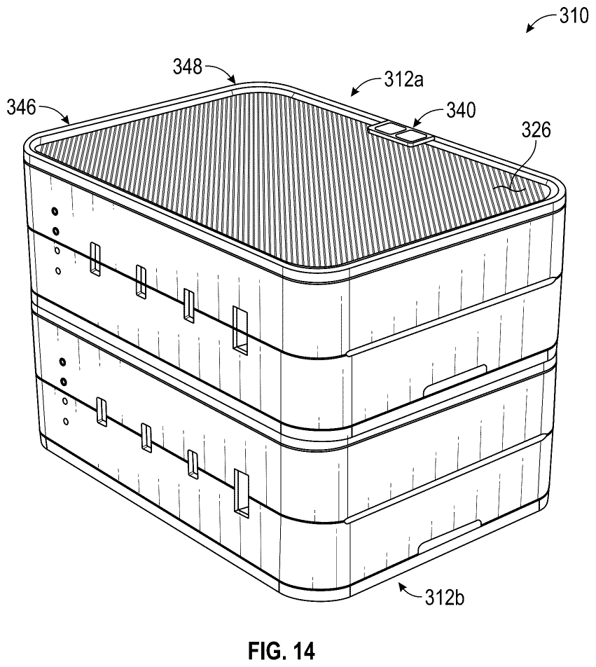

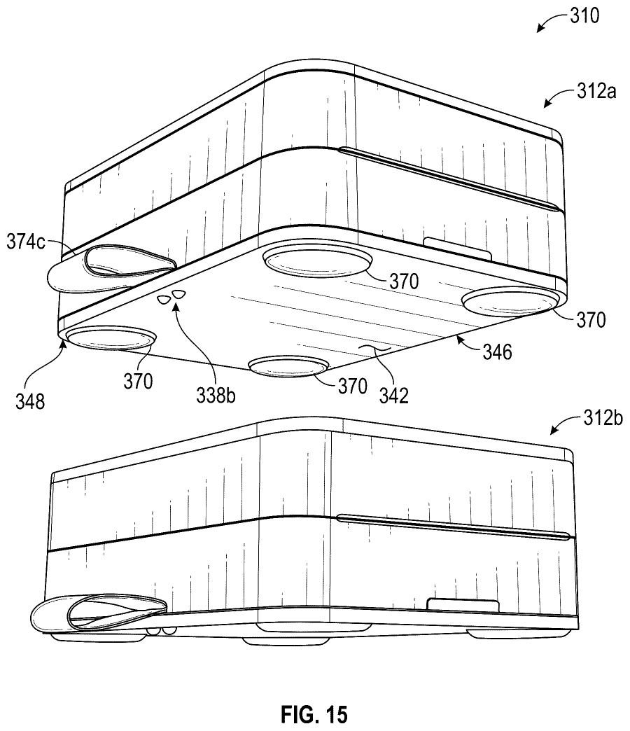

FIGS. 14 and 15 show another example of an electrical power system 310 including a first portable electrical power unit 312a that is similar to the first power unit 12a shown in FIGS. 1-8 but does not have a set of lower electrical contacts positioned on a front portion 346 of the power unit 312a. The corresponding elements of the electrical power system 310 use like reference numbers having the same last two digits (e.g., the power unit 312a is like the power unit 12a). The power unit 312a includes an upper surface 326 having a set of upper electrical contacts 340 positioned on a back portion 348 of the upper surface 326 (FIG. 14), and a lower surface 342 having a set of lower electrical contacts 338b positioned on a back portion 348 of the lower surface 342 (FIG. 15). The set of upper electrical contacts 340 includes a pair of flat contact pads, and the set of lower electrical contacts 338b includes a pair of spring-loaded pins that can contact a pair of contact pads for electrical coupling.

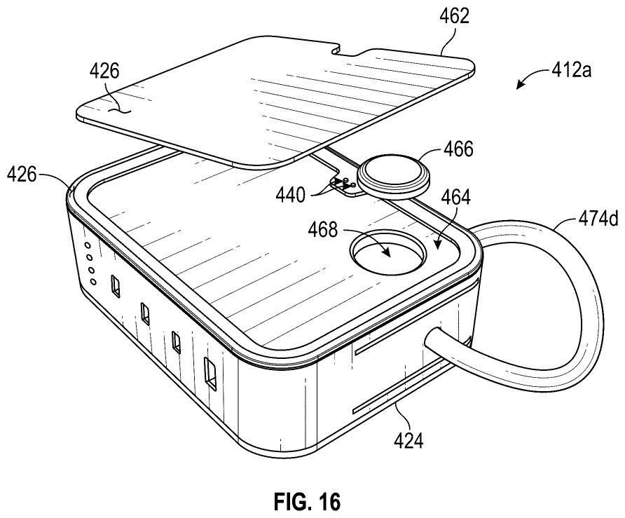

FIG. 16 shows another example of a portable electrical power unit 412a that is similar to the power unit 12a shown in FIGS. 1-8 but can hold an electronic tracking device 466 that may reduce the risks of theft and/or loss associated with the portability of the power unit 412a. The corresponding elements of the power unit 412a use like reference numbers having the same last two digits (e.g., a panel 462 of the power unit 412a is like the panel 62 of the power unit 12a). The tracking device 466 includes any suitable tracking technology such as, for example, a Global Positioning System (GPS) sensor, a near field communication (NFC) interface, an ultra-wideband interface, and/or a Bluetooth interface.

The power unit 412a includes the panel 462 that can conceal the tracking device 466. (FIG. 16). For example, the housing 424 defines a recess 464 that defines a tracking device cavity 468 for supporting the tracking device 466. (FIG. 16). The recess 464 can receive the panel 462 for concealing the tracking device 466 supported by the cavity 468. The panel 462 and the tracking device 466 are removable as shown in FIG. 16. Alternatively, the panel 462 and/or the tracking device 466 may be fixed.

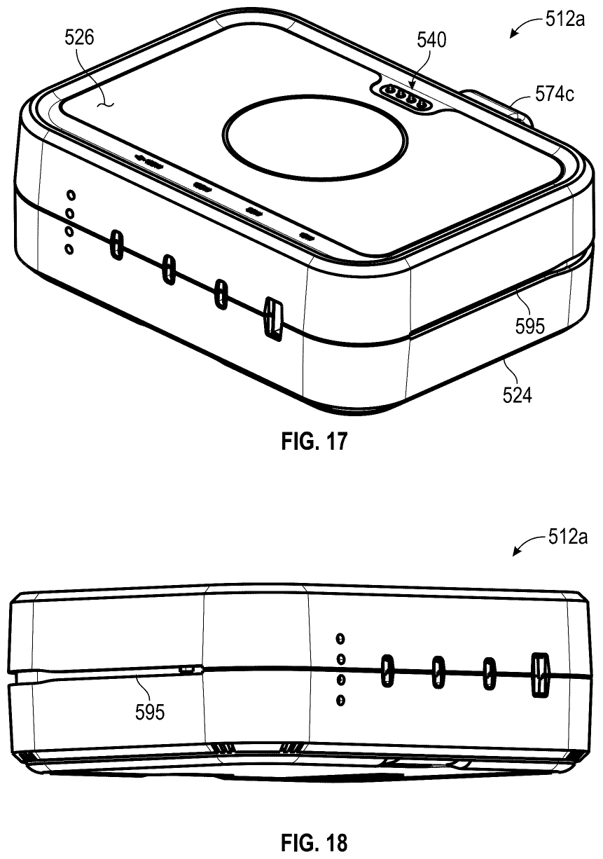

FIGS. 17-23 show another example of a portable electrical power unit 512a that is similar to the power unit 12a shown in FIGS. 1-8 and includes a housing 524 having an interior projection 576 that defines a tracking device cavity 578 for receiving a tracking device such as, for example, the electronic tracking device 466 of FIG. 16. The corresponding elements of the power unit 512a use like reference numbers having the same last two digits (e.g., the housing 524 is like the housing 24). The housing 524 has a lower side 580, and the interior projection 576 extends from the lower side 580 toward an upper surface 526 of the power unit 512a to a distal end. (FIG. 21).

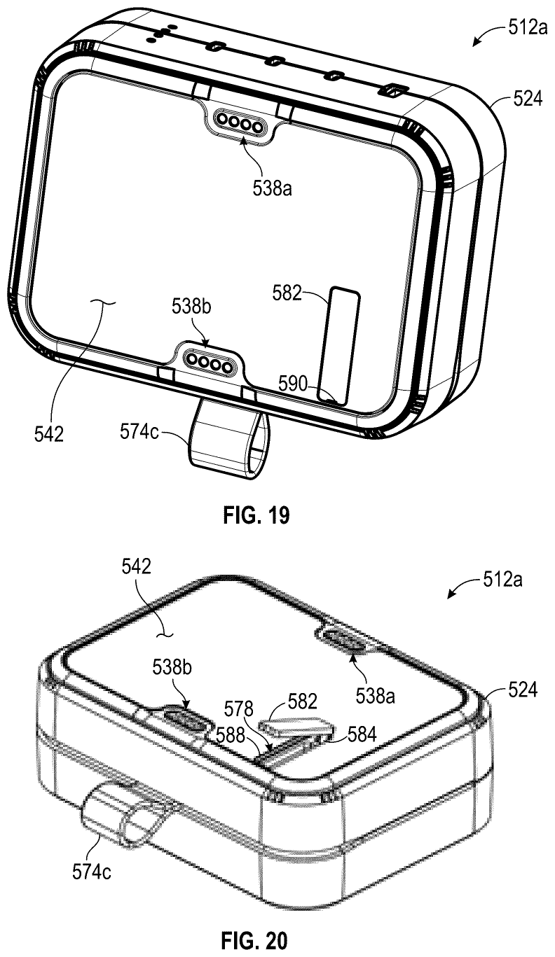

The power unit 512a has a cover 582 that can enclose the cavity 578 for concealing the tracking device in the cavity 578. (FIGS. 19-21). The cover 582 forms a portion of a lower surface 542 of the power unit 512a. The power unit 512a has a hinge 584 coupled to the cover 582 that can facilitate movement of the cover 582. The cover 582 can be moved between a closed position for enclosing the cavity 578 so that the tracking device in the cavity 578 can be concealed (FIG. 19), and an open position for exposing the cavity 578 so that the tracking device can enter and exit the cavity 578 (FIG. 20).

The power unit 512a includes a lower panel 586 that defines a wall 588 (FIGS. 20, 21) that can engage with an outer edge of the cover 582 when in the closed position to form a press fit or friction fit connection (FIG. 19). The cover 582 defines a recess 590 so that a space is defined between the wall 588 and the cover 582 when the cover 582 is in the closed position. The recess 590 can be engaged with to disengage the wall 588 and the outer edge of the cover 582. (FIG. 19). Alternatively, the cover 582 has one or more magnets so that the cover 582 can be magnetically retained to the lower panel 586 and/or housing 524 to conceal the cavity 578.

As shown in FIG. 21, the power unit 512a has a wireless electrical power receiver device 556 that can be covered by the lower panel 586 while still allowing power to transfer to the wireless receiver 556. The wireless receiver 556 is disposed below the battery 516 such that it is disposed between the lower panel 586 and the battery 516, and proximate to the lower surface 542. The power unit 512a has a wireless electrical power transmitter device 554, and an upper panel 562 for covering the wireless transmitter 554 while still allowing power to transfer from the wireless transmitter 554. The wireless transmitter 554 is disposed above the battery 516 such that it is disposed between the upper panel 562 and the battery 516, and proximate to the upper surface 526.

The power unit 512a includes a set of upper electrical contacts 540, and two sets of lower electrical contacts 538a, 538b. (FIGS. 17-21). The set of upper electrical contacts 540 includes two spring-loaded pins for transferring information (“communication pins”) such as, for example, data signals, and two spring-loaded pins for transferring power (“power pins”). The communication pins can contact two flat contact pads of another power unit for communicatively coupling, and the power pins can contact another two flat contact pads of the other power unit for electrical coupling.

The power pins of the set of upper electrical contacts 540 may not be energized until at least one of the communication pins obtains an indication that the power pins are in contact with respective contact pads of the other power unit for transferring power. For example, the indication may be in the form of a data electrical signal from the other power unit or a compression of the communication pin.

The communication pins of the set of upper electrical contacts 540 may further obtain an indication that the power pins are no longer in contact with respective contact pads of another power unit for transferring power. For example, the indication may be in the form of a loss in communication from the other power unit or a decompression of the communication pins. The power pins of the set of upper electrical contacts 540 may be de-energized in response to the communication pins obtaining an indication that the power pins are no longer in contact with respective contact pads of the other power unit.

Each of the sets of lower electrical contacts 538a, 538b includes two flat contact pads for transferring information (“communication pads”) such as, for example, data signals, and two flat contact pads for transferring power (“power pads”). The communication pads can contact two spring-loaded pins of another power unit for communicatively coupling, and the power pads can contact two spring-loaded pins of the other power unit for electrical coupling.

The power pads of the first set of lower electrical contacts 538a may not be energized until at least one of the communication pads in the first set of lower electrical contacts 538a obtains an indication that the first power pads are in contact with respective spring-loaded pins of another power unit for transferring power. The power pads of the second set of lower electrical contacts 538b may not be energized until at least one of the communication pads in the second set of lower electrical contacts 538b obtains an indication that the second power pads are in contact with respective spring-loaded pins of another power unit for transferring power. For example, the indication may be in the form of a data electrical signal from the other power unit.

The communication pads of the lower electrical contacts 538a, 538b may further obtain an indication that the power pads in the respective set of lower electrical contacts 538a, 538b are no longer in contact with the spring-loaded pins of the other power unit. For example, the indication may be in the form of a loss of communication with the other power unit. The power pads of the first set of lower electrical contacts 538a may be de-energized in response to the communication pads of the first set of lower electrical contacts 538a obtaining an indication that the first power pads are no longer in contact with respective spring-loaded pins of the other power unit. The power pads of the second set of lower electrical contacts 538b may be de-energized in response to the communication pads of the second set of lower electrical contacts 538b obtaining an indication that the second power pads are no longer in contact with respective spring-loaded pins of the other power unit.

The controller 544 may be communicatively coupled to the upper electrical contacts 540 and/or the lower electrical contacts 538a, 538b for transferring information with other power units and/or controlling whether the power pins and pads of the upper electrical contacts 540 and the lower electrical contacts 538a, 538b are energized. For example, the controller 544 may obtain information from communication pins or pads indicating that the power pads or pins in the respective set are contacting respective power pins or pads, and cause the power pads or pins to be energized based on this information. In another example, the controller 544 may obtain information from communication pins or pads indicating that the power pins or pads in the respective set are not contacting respective power pads or pins, and cause the power pins or pads to be de-energized based on this information.

In yet another example, the controller 544 may regulate the power transferred between the battery 516 and other power units based on information from the communication pins or pads that may indicate the charge levels of one or more batteries of other power units. In still another example, the controller 544 may provide information for the communication pins or pads to transfer to other power units that indicate the charge level of the battery 516.

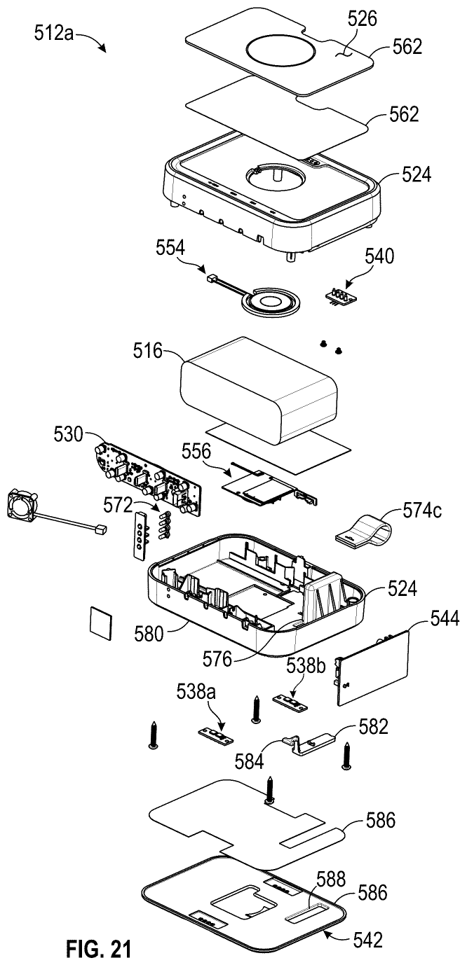

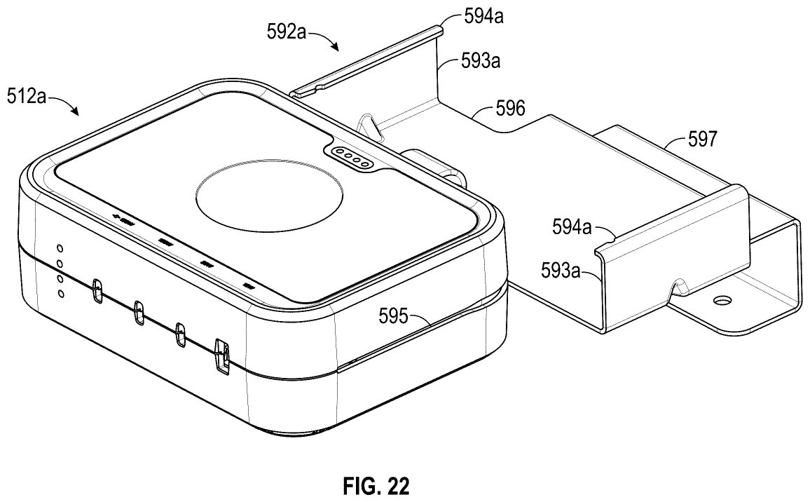

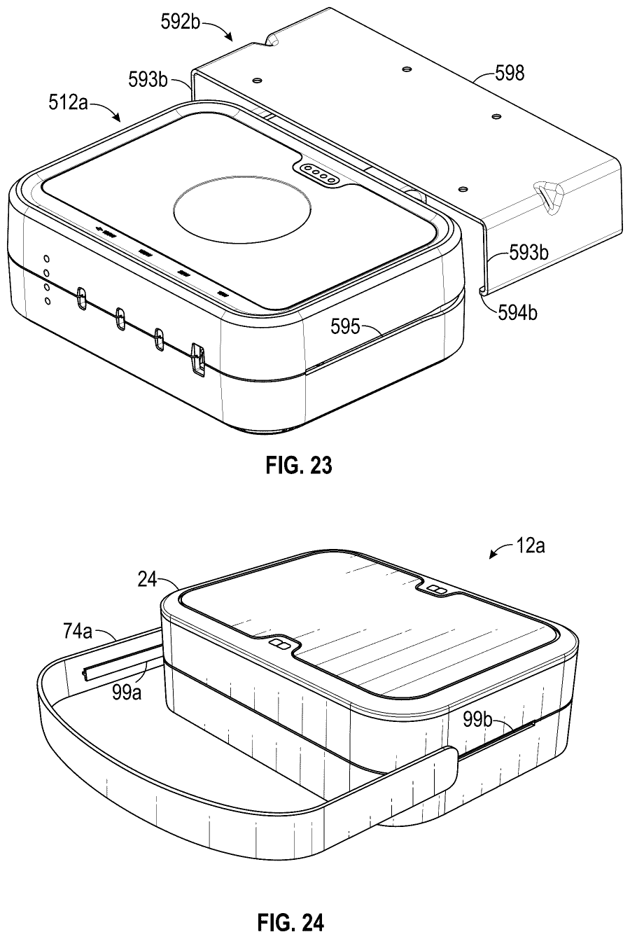

Referring to FIGS. 22 and 23, various mounting options for the power unit 512a are envisioned such as, for example, an edge mount 592a for top surface mounting (FIG. 22) and a U-bracket mount 592b for below surface mounting (FIG. 23). The mounts 592a, 592b include opposing sides 593a, 593b that have opposing ribs 594a, 594b. (FIGS. 22, 23). The power unit 512a has a pair of recessed channels 595 defined by opposing sides of the housing 524. (FIGS. 17, 18, 22, 23). The channels 595 of the power unit 512a can slidably engage with the ribs 594a, 594b of the mounts 592a, 592b for securing the power unit 512a to the mounts 592a, 592b.

As shown in FIG. 22, the edge mount 592a includes a lower platform 596 extending between the opposing sides 593a. The edge mount 592a includes a clamp 597 that is coupled to the lower platform 596. The clamp 597 can be secured to an edge portion of a support structure such as, for example, a desk, a table, a countertop, a shelf, or any other desired work surface. The clamp 597 has one or more openings that allow fasteners such as, for example, bosses to extend through the openings and further secure the edge mount 592a to the support structure.

As shown in FIG. 23, the U-bracket mount 592b includes an upper platform 598 extending between the opposing sides 593b. The upper platform 598 can be secured to a lower portion of a support structure such as, for example, a desk, a table, a countertop, a shelf, or other desired work surface. The upper platform 598 has one or more openings that allow fasteners such as, for example, bosses to extend through the openings and further secure the U-bracket mount 592b to the support structure.

In some examples, the lower platform 596 and/or the upper platform 598 may have a wireless electrical power transmitter device such as, for example, a transmitter that can transmit power according to a Qi standard for transferring power to the wireless receiver 556 while the power unit 512a is contacting the mounts 592a, 592b.

The portable electrical power units may implement various other features to improve usability. For example, as shown in FIG. 15, the lower surface 342 of the power unit 312a includes one or more grip pads 370 for restricting movement of the power unit 312a. In another example, as shown in FIGS. 1, 2, and 4, the power unit 12a includes one or more light sources 72 at the receptacle assembly 30 for indicating information, such as the charge level of the battery 16, the operation status of the wireless power transfer assembly 22, whether the power unit 12a is connected to an external power source, and the like. The light sources 72 may include light emitting diodes.

The light sources 72 may include a first light source 72 that can blink while the charge level of the battery 16 is between 0% and 25% of the full charge. When the charge level of the battery 16 is between 25% and 50% of the full charge, the first light source 72 may remain on without blinking, and a second of the light sources 72 may be blinking. When the charge level of the battery 16 is between 50% and 75% of the full charge, the first and second light sources 72 may remain on without blinking, and a third of the light sources 72 may be blinking. When the charge level of the battery 16 is between 75% and 100% of the full charge, the first, second, and third light sources 72 may remain on without blinking, and a fourth of the light sources 72 may be blinking. When the charge level of the battery 16 is fully charged, all of the light sources 72 may remain on.

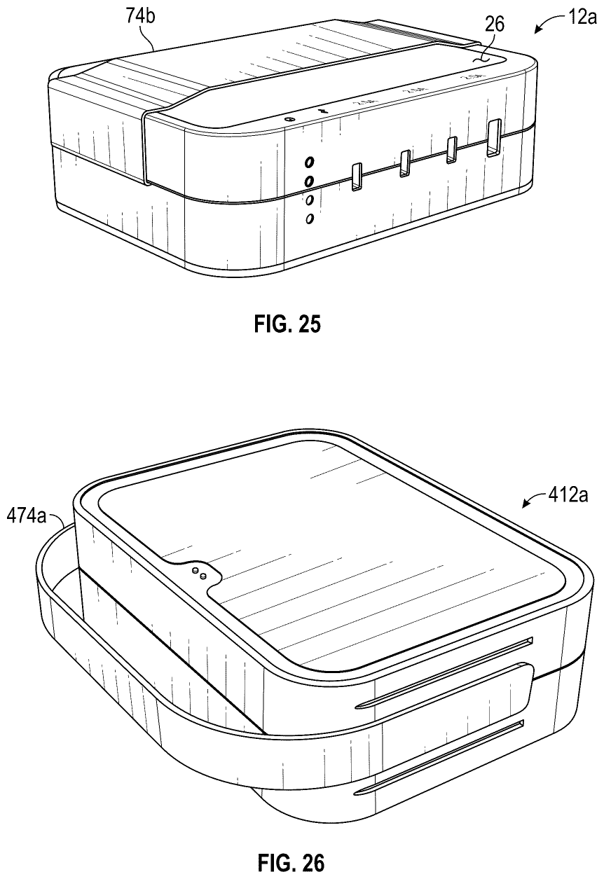

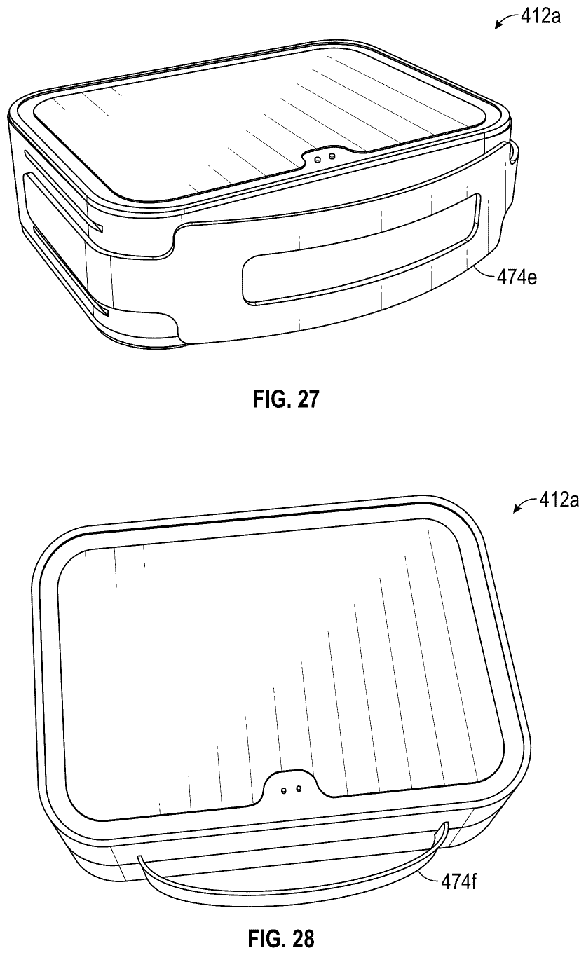

The portable electrical power units may implement various types of handles to facilitate handing and transport, and to reduce the risk of damage while handling the power units, such as due to dropping during transport. For example, as shown in FIGS. 1-4 and 24, the power unit 12a has a handle 74a that includes a pair of bearings or ribs 99a disposed on inner sides of the handle 74a that are movably coupled to respective recessed channels 99b defined by opposing side vertical surfaces of the housing 24. This allows the handle 74a to be moved along the channels 99b between a contracted position (FIGS. 1-4) and an expanded position (FIG. 24). The ribs 99a and channels 99b may be T-shaped. In another example, as shown in FIGS. 1 and 25, the power unit 12a has a handle 74b extending across the upper surface 26 (FIG. 25) that can be used to position the power unit 12a under the support structure 17 (FIG. 1). As shown in FIGS. 15-21, 27, and 28, other types of handles 374c, 574c, 474d-f can also be implemented.

Although examples of the portable electrical power units are shown in FIGS. 1-28, one or more of the elements illustrated in FIGS. 1-28 may be combined, divided, re-arranged, omitted and/or implemented in any other way. For example, the electrical contacts may be implemented by any other type of conductor capable of transferring electrical power such as, for example, fixed pins. In another example, the lower and upper electrical contacts of the power units may be re-arranged so that the lower surfaces each have one set of lower electrical contacts similar to the upper electrical contacts 540, and the upper surfaces each have two sets of upper electrical contacts similar to the lower electrical contacts 538a, 538b. (FIGS. 1-7, 9-12, 16-28).

Further, the portable electrical power units shown in FIGS. 1-28 may include one or more elements in addition to and/or instead of the elements shown in FIGS. 1-28, and/or may include more than one of the elements shown in FIGS. 1-28. For example, the power units may have one or more additional sets of electrical contacts.

The controller 44, the wireless power transfer assembly 22, and/or the electrical contact assembly 27 shown in FIGS. 5-8 may be implemented by hardware, software, firmware, and/or any combination of hardware, software, and/or firmware. The controller 44, the wireless power transfer assembly 22, and/or the electrical contact assembly 27 shown in FIGS. 5-8 could be implemented as one or more devices such as, for example, programmable processors (e.g., a field programmable gate array, a programmable logic controller), microprocessors (e.g., a central processing unit, a multi-core processor, a crypto processor, a digital signal processor, a graphics processing unit), microcomputers (e.g., an electronic control unit), microcontrollers, state machines, and/or circuits (e.g., an analog circuit, a logic circuit, a crypto circuit, an application specific integrated circuit).

Accordingly, the portable electrical power system includes a portable electrical power unit with a power interface that improves accessibility to power for electronic devices by having the capability to transfer power between electronic devices, other electrical power units, and/or a utility power source using wired and/or wireless power transmission. The battery of the power unit can be charged in a variety of manners and from a variety of power sources to improve the usability of the power unit. The power unit may be arranged in a stacked configuration with other electrical power units to provide more electronic devices access to electrical power without a larger footprint on a supporting surface of the stacked configuration and/or more external power connectors (e.g., outlets of a utility power grid).

Communications between elements are described herein using various terms such as, for example, “communicatively coupled.” As used herein, communications can be direct communications and/or indirect communications through one or more intermediary elements. Further, communications can be constant communication and/or selective communication at periodic intervals, scheduled intervals, aperiodic intervals, and/or one-time events.

Connection relationships between elements are described using various terms such as, for example, “connected”, “engaged”, “coupled”, and the like. As used herein, connection relationships can be direct relationships and/or indirect relationships where one or more intervening elements are between the first and second elements.

Spatial relationships between elements are described using various terms such as, for example, “front”, “back”, “upper”, “lower”, “top”, “bottom”, “side”, “vertical”, “horizontal”, and the like. As used herein, spatial relationships of the elements do not limit the orientations of the elements as other orientations of the elements may be used.

It should be understood that “including”, “comprising”, and “having” (and all other forms, such as tenses) are used herein to be open-ended terms. Thus, whenever a claim recites any form of “include”, “include”, or “have” (e.g., includes, includes, has, comprising, including, having) as a preamble or within a claim recitation of any kind, it is to be understood that additional elements, terms, etc. may be present without falling outside the scope of the corresponding claim.

As used herein, singular references (e.g., “a”, “an”, “first”, “second”) do not exclude a plurality. The term “a” or “an” entity refers to one or more of that entity. The terms “a” (or “an”), “one or more”, and “at least one” can be used interchangeably. The term “and/or” when used in a form such as, for example, A, B, and/or C refers to any combination or subset of A, B, C such as (1) A alone, (2) B alone, (3) C alone, (4) A with B, (5) A with C, (6) B with C, and (7) A with B and with C.

Changes and modifications in the specifically described examples can be carried out without departing from the principles of the present disclosure which is intended to be limited only by the scope of the appended claims, as interpreted according to the principles of patent law including the doctrine of equivalents.

1. An electrical power system comprising:
first and second power units each comprising:
opposing first and second horizontal surfaces;
a vertical surface extending between said horizontal surfaces;
an onboard rechargeable power source disposed between said surfaces;
a first set of power contacts electrically coupled to said onboard power source and disposed on said first horizontal surface;
second and third sets of power contacts electrically coupled to said onboard power source and disposed on said second horizontal surface; and
a plurality of electrical receptacles electrically coupled to said onboard power source and disposed along said vertical surface;
wherein said first and second power units are configured to be arranged in a first configuration where said first horizontal surface of said first power unit is in contact with said second horizontal surface of said second power unit and said first set of power contacts of said first power unit is: (i) in contact with said second set of power contacts of said second power unit, (ii) configured to transmit electrical power to said second set of power contacts of said second power unit to charge said onboard power source of said second power unit, and (iii) configured to receive electrical power from said second set of power contacts of said second power unit to charge said onboard power source of said first power unit;
wherein said first and second power units are configured to be arranged in a second configuration where said second horizontal surface of said first power unit is in contact with said first horizontal surface of said second power unit and said first set of power contacts of said second power unit is: (i) in contact with said second set of power contacts of said first power unit, (ii) configured to transmit electrical power to said second set of power contacts of said first power unit to charge said onboard power source of said first power unit, and (iii) configured to receive electrical power from said second set of power contacts of said first power unit to charge said onboard power source of said second power unit; and
wherein at least one of said electrical receptacles is configured to transmit electrical power to an electronic device, and at least one of said electrical receptacles is configured to receive electrical power from an external power source.

2. The electrical power system of claim 1, wherein said first and second power units are configured to be arranged in:
a third configuration where said first horizontal surface of said first power unit is in contact with said second horizontal surface of said second power unit and said first set of power contacts of said first power unit is: (i) in contact with said third set of power contacts of said second power unit, (ii) configured to transmit electrical power to said third set of power contacts of said second power unit to charge said onboard power source of said second power unit, and (iii) configured to receive electrical power from said third set of power contacts of said second power unit to charge said onboard power source of said first power unit; and
a fourth configuration where said second horizontal surface of said first power unit is in contact with said first horizontal surface of said second power unit and said first set of power contacts of said second power unit is: (i) in contact with said third set of power contacts of said first power unit, (ii) configured to transmit electrical power to said third set of power contacts of said first power unit to charge said onboard power source of said first power unit, and (iii) configured to receive electrical power from said third set of power contacts of said first power unit to charge said onboard power source of said second power unit.

3. The electrical power system of claim 2, wherein said first power unit is configured to be disposed in a first orientation relative to said second power unit when in said first and second configurations, and a second orientation relative to said second power unit when in said third and fourth configurations, wherein said first orientation is rotated 180 degrees relative to said second orientation.

4. The electrical power system of claim 3, wherein said vertical surface is a first vertical surface, wherein each of said power units comprises a second vertical surface opposing said first vertical surface and extending between said horizontal surfaces, wherein said first set of power contacts is disposed proximate to said second vertical surface, said second set of power contacts is disposed proximate to said second vertical surface, and said third set of power contacts is disposed proximate to said first vertical surface.

5. The electrical power system of claim 1, wherein each of said power units comprises a first set of communication contacts disposed on said first horizontal surface and proximate to said first set of power contacts, a second set of communication contacts disposed on said second horizontal surface and proximate to said second set of power contacts, and a third set of communication contacts disposed on said second horizontal surface and proximate to said third set of power contacts, wherein said communication contacts are configured to provide information.

6. The electrical power system of claim 5, wherein said power contacts of said first power unit are configured to selectively transmit and receive electrical power based on information provided from at least one of said communication contacts of said first power unit, and said power contacts of said second power unit are configured to selectively transmit and receive electrical power based on information provided from at least one of said communication contacts of said first power unit.

7. The electrical power system of claim 5, wherein said first set of power contacts of said first power unit is configured to be selectively energized when said first set of communication contacts of said first power unit is in contact with and communicatively coupled to either one of said second and third sets of communication contacts of said second power unit, wherein said second set of power contacts of said first power unit is configured to be selectively energized when said second set of communication contacts of said first power unit is in contact with and communicatively coupled to said first set of communication contacts of said second power unit, and wherein said third set of power contacts of said first power unit is configured to be selectively energized when said third set of communication contacts of said first power unit is in contact with and communicatively coupled to said first set of communication contacts of said second power unit.

8. The electrical power system of claim 7, wherein each of said first sets of power contacts and communication contacts comprises two spring-loaded pins, and wherein each of said second and third sets power contacts and communication contacts comprises two contact pads.

9. The electrical power system of claim 1, wherein each of said vertical surfaces are first vertical surfaces, wherein each of said power units comprises opposing second and third vertical surfaces extending from said first vertical surface and between said first and second horizontal surfaces, and wherein said second and third vertical surfaces define respective opposing recessed channels configured to slidably engage with respective ribs disposed on at least one of a handle and a mount.

10. The electrical power system of claim 1, wherein said electrical power system is configured so that said onboard power source of said first power unit will initially receive more electrical power from the external power source than said onboard power source of said second power unit when said power units are electrically coupled to one another, said onboard power source of said first power unit is at a lower charge level than said onboard power source of said second power unit, and at least one of said power units are receiving electrical power from an external power source.

11. The electrical power system of claim 1, wherein said electrical power system is configured so that said onboard power source of said first power unit will receive electrical power from said onboard power source of said second power unit when said power units are electrically coupled to one another, and said onboard power source of said first power unit is at a lower charge level than said onboard power source of said second power unit.

12. The electrical power system of claim 1, wherein each of said power units comprises a housing forming at least a portion of said surfaces and containing said onboard power source, wherein said housing defines a cavity configured to hold an electronic tracking device.

13. The electrical power system of claim 12, wherein each of said power units comprises a movable cover configured to selectively conceal said cavity.

14. The electrical power system of claim 13, wherein each of said housings comprises an interior projection having a first end proximate to said second horizontal surface and extending toward said first horizontal surface to a second end, wherein said interior projection defines said cavity.

15. The electrical power system of claim 1, further comprising a charging base including a platform, a fourth set of power contacts, and an electrical cord extending outwardly from said platform and having a distal end fitted with an electrical plug configured to engage with an electrical receptacle of an external power source, wherein said fourth set of power contacts is positioned to contact and be electrically coupled to either one of said second and third sets of power contacts.

16. The electrical power system of claim 1, wherein said second power unit is atop said first power unit when said first and second power units are arranged in said first configuration, and wherein said first power unit is atop said second power unit when said first and second power units are arranged in said second configuration.

17. An electrical power unit comprising:
opposing first and second horizontal surfaces;
a vertical surface extending between said horizontal surfaces;
an onboard rechargeable power source disposed between said surfaces;
a first set of power contacts electrically coupled to said onboard power source and disposed on said first horizontal surface;
second and third sets of power contacts electrically coupled to said onboard power source and disposed on said second horizontal surface;
a plurality of electrical receptacles electrically coupled to said onboard power source and disposed along said vertical surface;
wherein at least one of said electrical receptacles is configured to selectively transmit electrical power to an electronic device;
wherein at least one of said electrical receptacles is configured to selectively receive electrical power from an external power source; and
wherein said power contacts are configured to: (i) selectively transmit electrical power to a second electrical power unit, and (ii) selectively receive electrical power from the second electrical power unit for charging said onboard power source.

18. The electrical power unit of claim 17, wherein said vertical surface is a first vertical surface, wherein said electrical power unit further comprises opposing second and third vertical surfaces extending from said first vertical surface and between said first and second horizontal surfaces, and wherein said second and third vertical surfaces define respective opposing recessed channels configured to slidably engage with respective ribs disposed on at least one of a handle and a mount.

19. The electrical power unit of claim 17, further comprising a first set of communication contacts disposed on said first horizontal surface and proximate to said first set of power contacts, a second set of communication contacts disposed on said second horizontal surface and proximate to said second set of power contacts, and a third set of communication contacts disposed on said second horizontal surface and proximate to said third set of power contacts, wherein said communication contacts are configured to provide information; and
wherein said first set of power contacts is configured to be selectively energized when said first set of communication contacts is in contact with and communicatively coupled to the second electrical power unit, wherein said second set of power contacts is configured to be selectively energized when said second set of communication contacts is in contact with and communicatively coupled to the second electrical power unit, and wherein said third set of power contacts is configured to be selectively energized when said third set of communication contacts is in contact with and communicatively coupled to the second electrical power unit.

20. An electrical power system comprising:
first and second power units each comprising:
opposing first and second horizontal surfaces;
opposing first and second vertical surfaces extending between said horizontal surfaces;
opposing third and fourth vertical surfaces extending between said horizontal surfaces and between said first and second vertical surfaces;
a housing forming at least a portion of said surfaces;
an onboard rechargeable power source disposed within said housing;
two spring-loaded communication pins disposed on said first horizontal surface and proximate to said first vertical surface, and configured to provide first information;
two spring-loaded power pins electrically coupled to said onboard power source and disposed on said first horizontal surface and proximate to said spring-loaded communication pins, and configured to be selectively energized based on said first information;
two first communication contact pads disposed on said second horizontal surface and proximate to said first vertical surface, and configured to provide second information;
two first power contact pads electrically coupled to said onboard power source and disposed on said second horizontal surface and proximate to said first communication contact pads, and configured to be selectively energized based on said second information;
two second communication contact pads disposed on said second horizontal surface and proximate to said second vertical surface, and configured to provide third information;
two second power contact pads electrically coupled to said onboard power source and disposed on said second horizontal surface and proximate to said second communication contact pads, and configured to be selectively energized based on said third information;
a plurality of electrical receptacles electrically coupled to said onboard power source and disposed along said second vertical surface;
a wireless electrical power receiver electrically coupled to said onboard power source, and disposed proximate to said second horizontal surface;
a wireless electrical power transmitter electrically coupled to said onboard power source, and disposed proximate to said first horizontal surface; and
a pair of recessed channels defined by respective ones of said third and fourth vertical surfaces, and configured to slidably engage with respective ribs disposed on at least one of a handle and a mount;
wherein said first and second power units are configured to be arranged in a first configuration where said first horizontal surface of said first power unit is in contact with said second horizontal surface of said second power unit and said first set of power contacts of said first power unit is: (i) in contact with said second set of power contacts of said second power unit, (ii) configured to transmit electrical power to said second set of power contacts of said second power unit to charge said onboard power source of said second power unit, and (iii) configured to receive electrical power from said second set of power contacts of said second power unit to charge said onboard power source of said first power unit;
wherein said first and second power units are configured to be arranged in a second configuration where said second horizontal surface of said first power unit is in contact with said first horizontal surface of said second power unit and said first set of power contacts of said second power unit is: (i) in contact with said second set of power contacts of said first power unit, (ii) configured to transmit electrical power to said second set of power contacts of said first power unit to charge said onboard power source of said first power unit, and (iii) configured to receive electrical power from said second set of power contacts of said first power unit to charge said onboard power source of said second power unit;
wherein said first and second power units are configured to be arranged in a third configuration where said first horizontal surface of said first power unit is in contact with said second horizontal surface of said second power unit and said first set of power contacts of said first power unit is: (i) in contact with said third set of power contacts of said second power unit, (ii) configured to transmit electrical power to said third set of power contacts of said second power unit to charge said onboard power source of said second power unit, and (iii) configured to receive electrical power from said third set of power contacts of said second power unit to charge said onboard power source of said first power unit;
wherein said first and second power units are configured to be arranged in a fourth configuration where said second horizontal surface of said first power unit is in contact with said first horizontal surface of said second power unit and said first set of power contacts of said second power unit is: (i) in contact with said third set of power contacts of said first power unit, (ii) configured to transmit electrical power to said third set of power contacts of said first power unit to charge said onboard power source of said first power unit, and (iii) configured to receive electrical power from said third set of power contacts of said first power unit to charge said onboard power source of said second power unit;
wherein said first power unit is configured to be disposed in a first orientation relative to said second power unit when in said first and second configurations;
wherein said first power unit is configured to be disposed in a second orientation relative to said second power unit when in said third and fourth configurations;
wherein said first orientation is rotated 180 degrees relative to said second orientation; and
wherein at least one of said electrical receptacles is configured to transmit electrical power to an electronic device, and at least one of said electrical receptacles is configured to receive electrical power from an external power source.
